(19) United States
(12) Patent Application Publication
(10) Pub. No.: US 2019/0024265 A1
(43) Pub. Date: Jan. 24, 2019

(54) FILAMENT FOR AN ADDITIVE MANUFACTURING PROCESS

(71) Applicant: GM GLOBAL TECHNOLOGY OPERATIONS LLC, Detroit, MI (US)

(72) Inventors: Julien P. Mourou, Bloomfield Hills, MI (US); Paul J. Wolcott, Macomb, MI (US)

(73) Assignee: GM GLOBAL TECHNOLOGY OPERATIONS LLC, Detroit, MI (US)

(21) Appl. No.: 15/653,011

(22) Filed: Jul. 18, 2017

(51) Int. Cl. D01F 8/18; B33Y 70/00; D01F 8/12; D01F 8/08; D01F 8/14; D01F 8/16

(52) U.S. Cl. CPC D01F 8/18; B33Y 70/00; D01F 8/12; B29C 64/165; D01F 8/14; D01F 8/16; D01F 8/08

(57) ABSTRACT

A filament suitable for use with a fused filament fabrication process includes an elongated body. The elongated body defines and extends along a central longitudinal axis of the elongated body. The filament includes at least one continuous reinforcing strand, which is encapsulated within the elongated body. The continuous reinforcing strand extends uninterrupted between a first end and a second end of the elongated body, along the central longitudinal axis. The elongated body includes a ferromagnetic sensitive element that is capable of inductively heating the elongated body. The ferromagnetic sensitive element may include iron particles mixed with the polymer forming the elongated body, or may be formed by the continuous reinforcing strand including a ferromagnetic sensitive material.

### INTRODUCTION

The disclosure generally relates to a filament that may be used for an additive manufacturing process, such as a fused filament fabrication process.

A fused filament fabrication process is a form of an additive manufacturing process, which uses a filament to build a three dimensional object. The filament is an elongated strand of material, generally a polymer, which is the feedstock for an extrusion machine. The filament is fed into a nozzle of the extrusion machine. The nozzle heats the filament to melt the material of the filament. The heated filament is then deposited in layers to form the object.

### SUMMARY

A filament for an additive manufacturing process is provided. The filament includes an elongated body. The elongated body defines and extends along a central longitudinal axis of the elongated body. The filament includes at least one continuous reinforcing strand, which is encapsulated within the elongated body. The continuous reinforcing strand extends along the central longitudinal axis.

In one aspect of the filament described herein, the elongated body extends a length along the central longitudinal axis, between a first end and a second end. The continuous reinforcing strand extends uninterrupted along the entire length of the elongated body.

In another aspect of the filament described herein, the elongated body is a polymer. The polymer of the elongated body may include, but is not limited to, one of Acrylonitrile butadiene styrene (ABS), Polylactide (PLA), Polyetherimide (PEI), or nylon.

In one embodiment of the filament described herein, the continuous reinforcing strand is one of a glass fiber, a carbon fiber, or a metal fiber.

In one embodiment of the filament described herein, the continuous reinforcing strand includes a plurality of continuous reinforcing strands. Each of the plurality of reinforcing strands is laterally spaced from the others within the elongated body.

In one aspect of the filament described herein, the filament includes a ferromagnetic sensitive element that is capable of inductively heating the elongated body. The ferromagnetic sensitive element may include an electrically conductive material. In one embodiment of the filament, the ferromagnetic sensitive element includes a particulate matter mixed throughout the elongated body. In one embodiment the elongated body includes a mixture of a polymer and a ferromagnetic sensitive particulate matter. The particulate matter may include iron particles. In another embodiment, the continuous reinforcing strand includes ferromagnetic sensitive material, which forms the ferromagnetic sensitive element. As such, the continuous reinforcing strand is also the ferromagnetic sensitive element.

Accordingly, the continuous reinforcing strand increases the strength of the filament, thereby increasing the strength of an object formed from the filament using the fused filament fabrication process. The ferromagnetic sensitive element may be used to heat the elongated by through inductive heating, which quickly heats the elongated body through to a center of the elongated body.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic perspective partially sectioned view of a first embodiment of a filament.

FIG. 2 is a schematic cross sectional view of the first embodiment of the filament parallel to a central longitudinal axis of the filament.

FIG. 3 is a schematic cross sectional view of the first embodiment of the filament perpendicular to the central longitudinal axis of the filament.

FIG. 4 is a schematic perspective partially sectioned view of a second embodiment of the filament.

FIG. 5 is a schematic cross sectional view of the second embodiment of the filament parallel to the central longitudinal axis of the filament.

FIG. 6 is a schematic cross sectional view of the second embodiment of the filament perpendicular to the central longitudinal axis of the filament.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

Referring to the FIGS., wherein like numerals indicate like parts throughout the several views, a filament is generally shown at 20. The filament 20 may be used for an additive manufacturing process, including but not limited to a fused filament fabrication process. Generally, the fused filament fabrication process uses the filament 20 to construct three dimensional objects. The filament 20 is fed into an extrusion machine. A nozzle of the extrusion machine heats the filament 20 to soften the filament 20. The heated filament 20 is then deposited in layers to form the object. The specific process for the fused filament fabrication process, and the specific construction of the extrusion machine are not pertinent to the teachings of this disclosure, and are therefore not described in detail herein.

The filament 20 includes an elongated body 22. The elongated body 22 defines a central longitudinal axis 24. The elongated body 22 extends along the central longitudinal axis 24, between a first end 26 and a second end 28. The central longitudinal axis 24 is generally defined by a center of the elongated body 22. The elongated body 22 defines a length 30 between the first end 26 and the second end 28 of the elongated body 22. As shown in the drawings, exemplary embodiments of the filament 20 described herein are shown as having a circular or round cross sectional shape perpendicular to the central longitudinal axis 24. However, it should be appreciated that the cross sectional shape of the filament 20 may differ from the exemplary circular cross sectional shape shown and described herein. Furthermore, while the exemplary embodiments of the filament 20 are shown as linear or straight in the drawings, it should be appreciated that the filament 20 may be coiled or wound around a spool. As such, it should be appreciated that the central longitudinal axis 24 may not be linear, such as shown in the drawings, but may alternatively define a non-linear path.

In the exemplary embodiment described herein, the elongated body 22 is formed from a polymer. The polymer may include, but is not limited to, one of Acrylonitrile butadiene styrene (ABS), Polylactide (PLA), Polyetherimide (PEI), or nylon. It should be appreciated that the polymer forming the elongated body 22 may include some other material not specifically described herein, and that the particular material used to form the elongated body 22 is dependent upon the specific object being formed. Furthermore, while the exemplary embodiment describes the elongated body 22 as being formed from a polymer, it should be appreciated that the elongated body 22 may be formed from a non-polymer material that is suitable for use in the fused filament fabrication process.

The filament 20 includes at least one continuous reinforcing strand 32. The continuous reinforcing strand 32 is encapsulated within the elongated body 22. The continuous reinforcing strand 32 extends along the central longitudinal axis 24, in an uninterrupted manner, along the entire length 30 of the elongated body 22, i.e., between the first end 26 and the second end 28 of the elongated body 22. Accordingly, it should be appreciated that the continuous reinforcing strand 32 is not chopped or short fiber fillers, but is instead a continuous strand extending along the length 30 of the elongated body 22.

The continuous reinforcing strand 32 may include and be formed from any material suitable for use in the fused filament fabrication process that is capable of strengthening the material forming the elongated body 22. For example, the continuous reinforcing strand 32 may include, but is not limited to, one of a glass fiber strand, a carbon fiber strand, or a metal fiber strand. The continuous reinforcing strand 32 increases the strength of the elongated body 22 to a larger extent than chopped reinforcing fibers. Accordingly, incorporating the continuous reinforcing strand 32 into the elongated body 22 increases the strength and durability of the filament 20, which increases the strength and durability of the object formed from the filament 20 with the fusion filament 20 fabrication process.

The filament 20 may include a ferromagnetic sensitive element 34. The ferromagnetic sensitive element 34 is capable of inductively heating the elongated body 22. Generally, induction heating is a process of heating an electrically conducting object by electromagnetic induction, through heat generated in the object by eddy currents. Accordingly, the ferromagnetic sensitive element 34 may include an electrically conductive material, such as a metal. The filament 20 may therefore be heated through induction heating during the fusion filament 20 fabrication process.

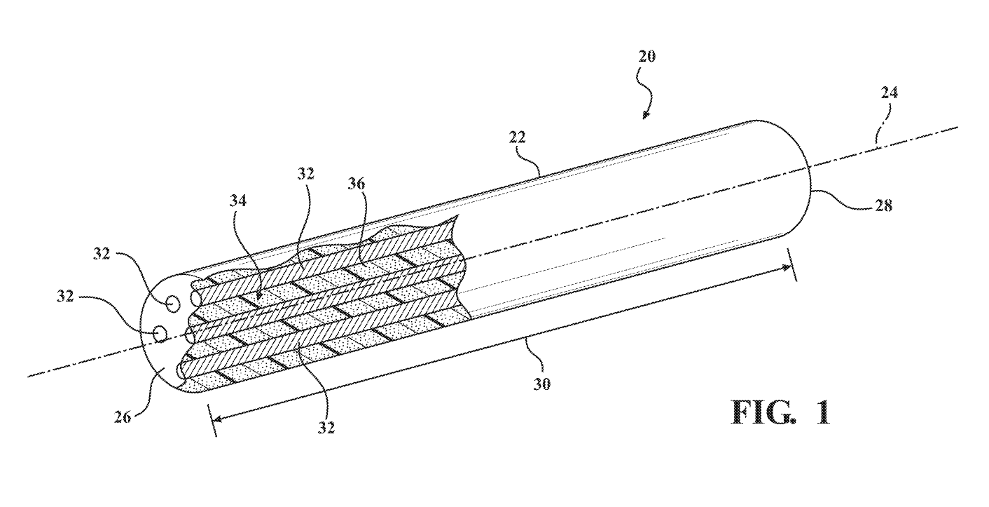

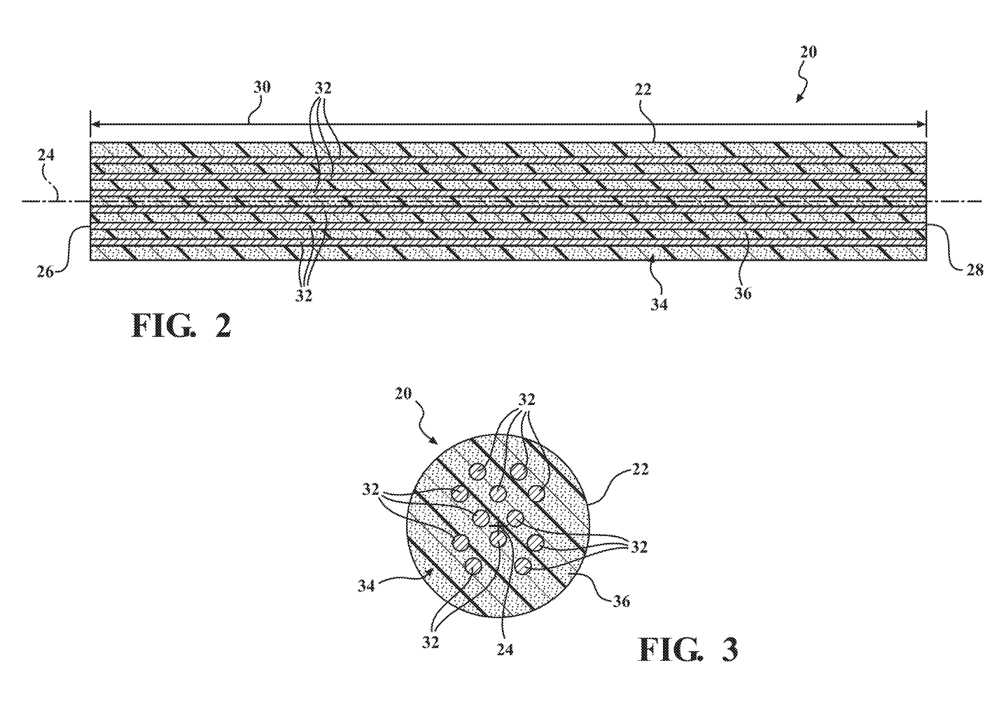

Referring to FIGS. 1-3, a first alternative embodiment of the filament 20 is shown. As shown in the first embodiment of the filament 20, the at least one continuous reinforcing strand 32 includes a plurality of continuous reinforcing strands 32. Each of the continuous reinforcing strand 32s is laterally spaced from the other reinforcing strands within the elongated body 22. As such, each of the continuous reinforcing strand 32s is encapsulated by the elongated body 22. The continuous reinforce strands of the first alternative embodiment of the filament 20 may include carbon fiber strands, glass fiber strands, or some other non-metallic strands.

The ferromagnetic sensitive element 34 of the first alternative embodiment of the filament 20 includes a particulate matter 36 mixed throughout the elongated body 22. Accordingly, the elongated body 22 includes a mixture of a polymer and a ferromagnetic sensitive particulate matter 36. For example, the particulate matter 36 may include, but is not limited to, iron particles. It should be appreciated than any ferromagnetic sensitive particulate matter 36 may be mixed with the polymer forming the elongated body 22 to provide the ferromagnetic sensitive element 34. The particulate matter 36 may be evenly distributed through the cross section of the elongated body 22, perpendicular to the central longitudinal axis 24, and may be evenly distributed axially through the elongated body 22, along the central longitudinal axis 24, in order to provide even heating of the elongated body 22.

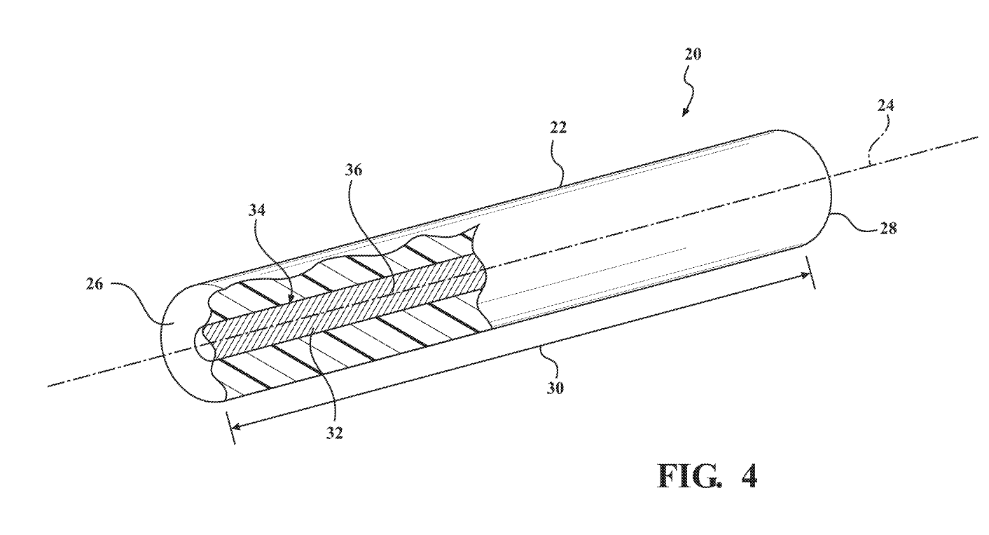

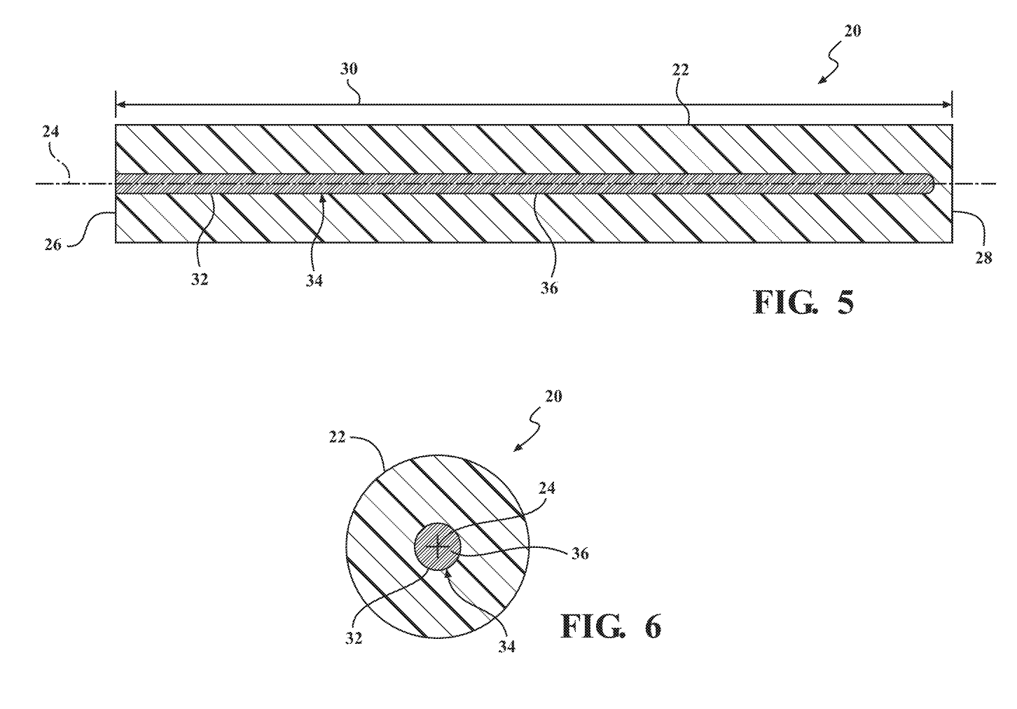

Referring to FIGS. 4-6, a second alternative embodiment of the filament 20 is shown. The at least one continuous reinforcing strand 32 of the second embodiment of the filament 20 is formed from a ferromagnetic sensitive material. The ferromagnetic sensitive material may include, but is not limited to, an iron strand. As such, the continuous reinforcing strand 32 also forms the ferromagnetic sensitive element 34. Accordingly, the continuous reinforcing strand 32 both reinforces the elongated body 22, and is used to inductively heat the elongated body 22. While the second alternative embodiment of the filament 20 is shown having only a single continuous reinforcing strand 32, it should be appreciated that the second alternative embodiment of the filament 20 may include multiple continuous reinforcing strand 32s.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. A filament for an additive manufacturing process, the filament comprising:
an elongated body defining and extending along a central longitudinal axis;
at least one continuous reinforcing strand encapsulated within the elongated body, and extending along the central longitudinal axis.

2. The filament set forth in claim 1, wherein the elongated body extends a length along the central longitudinal axis, and wherein the at least one continuous reinforcing strand extends uninterrupted along the entire length of the elongated body.

3. The filament set forth in claim 1, wherein the at least one continuous reinforcing strand is one of a glass fiber, a carbon fiber, or a metal fiber.

4. The filament set forth in claim 1, wherein the at least one continuous reinforcing strand includes a plurality of continuous reinforcing strands laterally spaced from each other within the elongated body.

5. The filament set forth in claim 1, further comprising a ferromagnetic sensitive element capable of inductively heating the elongated body.

6. The filament set forth in claim 5, wherein the ferromagnetic sensitive element is an electrically conductive material.

7. The filament set forth in claim 5, wherein the ferromagnetic sensitive element includes a particulate matter mixed throughout the elongated body.

8. The filament set forth in claim 7, wherein the particulate matter is iron particles.

9. The filament set forth in claim 5, wherein the at least one continuous reinforcing strand includes ferromagnetic sensitive material forming the ferromagnetic sensitive element.

10. The filament set forth in claim 1, wherein the elongated body is a polymer.

11. The filament set forth in claim 1, wherein the elongated body includes one of Acrylonitrile butadiene styrene (ABS), Polylactide (PLA), Polyetherimide (PEI), or nylon.

12. The filament set forth in claim 1, wherein the elongated body includes a mixture of a polymer and a ferromagnetic sensitive particulate matter.

13. A filament suitable for use with a fused filament fabrication process, the filament comprising:
an elongated body defining and extending along a central longitudinal axis;
wherein the elongated body extends a length along the central longitudinal axis, between a first end and a second end of the elongated body, and includes a mixture of a polymer and a ferromagnetic sensitive particulate matter; and
at least one continuous reinforcing strand encapsulated within the elongated body, and extending along the central longitudinal axis;
wherein the at least one continuous reinforcing strand extends uninterrupted along the entire length of the elongated body.

14. The filament set forth in claim 13, wherein the at least one continuous reinforcing strand is one of a glass fiber, a carbon fiber, or a metal fiber.

15. The filament set forth in claim 13, wherein the at least one continuous reinforcing strand includes a plurality of continuous reinforcing strands laterally spaced from each other within the elongated body.

16. The filament set forth in claim 13, wherein the ferromagnetic sensitive particulate matter is iron particles.

17. The filament set forth in claim 13, wherein the polymer of the elongated body includes one of Acrylonitrile butadiene styrene (ABS), Polylactide (PLA), Polyetherimide (PEI), or nylon.

18. A filament suitable for use with a fused filament fabrication process, the filament comprising:
an elongated body defining and extending along a central longitudinal axis;
wherein the elongated body extends a length along the central longitudinal axis, between a first end and a second end of the elongated body, and includes a polymer;
at least one continuous reinforcing strand encapsulated within the elongated body, and extending along the central longitudinal axis;
wherein the at least one continuous reinforcing strand extends uninterrupted along the entire length of the elongated body; and
wherein the at least one continuous reinforcing strand includes a ferromagnetic sensitive matter capable of inductively heating the elongated body.

19. The filament set forth in claim 18, wherein the at least one continuous reinforcing strand is iron.

20. The filament set forth in claim 18, wherein the polymer of the elongated body includes one of Acrylonitrile butadiene styrene (ABS), Polylactide (PLA), Polyetherimide (PEI), or nylon.
